(19) United States
(12) Patent Application Publication
(10) Pub. No.: US 2024/0115968 A1
(43) Pub. Date: Apr. 11, 2024

(54) Miniature Construction Set

(71) Applicants: James Jimmy Christian Hotz, Thousand Oaks, CA (US); Ted Joseph Gatto, Glendale, CA (US)

(72) Inventors: James Jimmy Christian Hotz, Thousand Oaks, CA (US); Ted Joseph Gatto, Glendale, CA (US)

(21) Appl. No.: 18/045,173

(22) Filed: Oct. 9, 2022

(51) Int. Cl. A63H 33/04; A63H 5/00; A63H 33/10; A63H 33/22; F21V 23/00; F21V 33/00

(52) U.S. Cl. CPC A63H 33/042; A63H 5/00; A63H 33/10; A63H 33/22; F21V 23/003; F21V 33/008; F21Y 2115/10

(57) ABSTRACT

A construction set for creating entertainment event venues such as concerts, sporting events, TV show sets and futuristic entertainment venues. Assembled components are utilized when they are practical for a specific purpose but assembly kits for the components are also available for those wishing to build them from the construction set's basic parts. Components include but are not limited to stage platforms, truss, audio inputs, audio outputs, video monitors, holographic images, as well as other components, accessories and moving lights which are archetypal for creating entertainment venues. Unique eight pointed star connectors are used for connecting many of the components together. Additionally a master control system computer provides real-time interactive control of lighting, effects and robotics through USB, MIDI, DMX and other connections and protocols, which can be wired or wireless. It can also be controlled through audio from files, live microphones or live feeds from computers and smartphones.

### BACKGROUND

### Field of the Invention

The present invention relates generally to construction sets. More particularly the present invention relates to construction sets which allow anyone to create, on a miniature scale, entertainment event venues of all kinds, including but not limited to: concerts, clubs, TV show sets, studios, conventions and sporting events. The present invention includes unique connectors which are easily alignable and superior in numerous ways as well as real-time interactive elements including but not limited to lighting, effects, video, audio and robotic movement.

### Description of the Related Art

There are and have been construction sets such as the Erector Set—U.S. Pat. No. 1,066,809 invented by Alfred Carlton Gilbert for “Toy Construction Blocks”; an illuminated toy construction kit—U.S. Pat. No. 8,371,894B1 invented by Lawrence Rosen and Parviz Daftari for “Illuminated toy construction kit”; a Magnetic construction toy—U.S. Pat. No. 9,713,777B2 invented by Laura E. Peterson for “Magnetic construction toy”. While each of these have provided some level of creativity and enjoyment for the end user there is a need for an improved construction set.

### SUMMARY

A primary objective of the present invention is to provide a means for end users of all ages to easily and creatively assemble entertainment event venues that have an immersive quality and realistic look on a level that has not been previously achieved in construction sets. Another objective of the present invention is to provide, in a construction set, an unprecedented level of cohesive, real-time interactivity with various components including but not limited to: lighting, sound, video, robotics and other components which are part of the miniature construction set. Yet another objective of the present invention is to provide unique connectors that provide more easy assembly and greater holding power. It is also an objective of the present invention to provide the most complete set of components ever available for creating entertainment event venues on a miniature scale and provide compelling and lifelong interactive experiences on an unprecedented level.

### BRIEF DESCRIPTION OF THE INVENTION

The present invention includes a variety of components including but not limited to stage components, truss components, unique connectors and other components which can easily be put together to create various types of entertainment venues such as concerts, sporting events, TV show sets and futuristic entertainment venues on a wide range of physical sizes, price points and levels of interactivity. The flagship miniature construction set is designed to be the most complete set of components and accessories for creating such venues on an unprecedented level and provides the foundation of a new product ecosystem. Both programmed and real-time interactive components, including but not limited to synchronized lighting, holographic effects, audio and video along with robotic movement of various components are a key part of the invention. It is also designed to have a very simple and inexpensive entry point that allows anyone to grow their miniature construction set over a lifetime into their own truly unique experience with any level of interactivity and complexity they desire. The scale can range from a small preassembled collectible that fits on a shelf, to large dioramas for one's home or place of business, to entire miniature construction set amusement parks with numerous entertainment venue experiences. It is envisioned that the miniature construction set will bring into existence an entire new product ecosystem and a new form of home entertainment whereby one can create their own entertainment world that can be share with others through: videos, photos, real-time on-line experiences, websites, TV shows, contests, in-person experiences and other means of sharing. One would never outgrow the miniature construction set ecosystem as it is designed from the beginning to be compelling to all ages and be easily expandable.

### BRIEF DESCRIPTION OF THE DRAWINGS

FIG. 1 is a perspective view of a concert venue which can be created with a preferred embodiment of the miniature construction set and within the drawing the various components which can be used to construct it are identified.

FIG. 2 is a different perspective view of the concert venue shown in FIG. 1.

FIG. 3 shows a number of the basic components used in the miniature construction set such as stage components, connectors and various truss components.

FIG. 4 shows a sound and light control tower and the various miniature construction set components used to construct it.

FIG. 5 shows various types of speaker components which are part of the miniature construction set.

FIG. 6 shows various types of stairs and ladder components which are part of the miniature construction set.

FIG. 7 shows a perspective view of the inside of a club and identifies the various miniature construction set components which can be used to construct it.

FIG. 8 shows a power and control bus which can provide power and control signals to the components in the miniature construction set that need power and/or control signals. The miniature construction set Power and Control Bus helps provides the unprecedented level of cohesive, real-time interactivity in the miniature construction set.

FIG. 9 shows a number of lighting components which are part of the miniature construction set.

FIG. 10 shows motorized focus-able spotlights, a motorized mirror ball, a motorized rotating platform and a remote controllable miniature construction set robotics interface which are part of the miniature construction set.

FIG. 11 shows a number of dioramas which can be created using large video monitor components and projector components as part of the miniature construction set, these include both 2D and 3D video monitors and projectors.

FIG. 12 shows various holographic stage components and display components which can be incorporated into the miniature construction set.

FIG. 13 shows a number of MIDI and DMX controllers which can be used to control the miniature construction set.

FIG. 14 shows a number of controllable MIDI and DMX components which can be controlled by the miniature construction set.

FIG. 15 shows a number of figurine components which are part of the miniature construction set.

FIG. 16 shows some of the components which utilize unique miniature construction set connectors and more detailed views of the connectors.

FIG. 17 shows more of the components which utilize unique miniature construction set connectors and further detailed views of the connectors.

### DETAILED DESCRIPTION OF THE DRAWINGS

With reference to the drawings there is shown in:

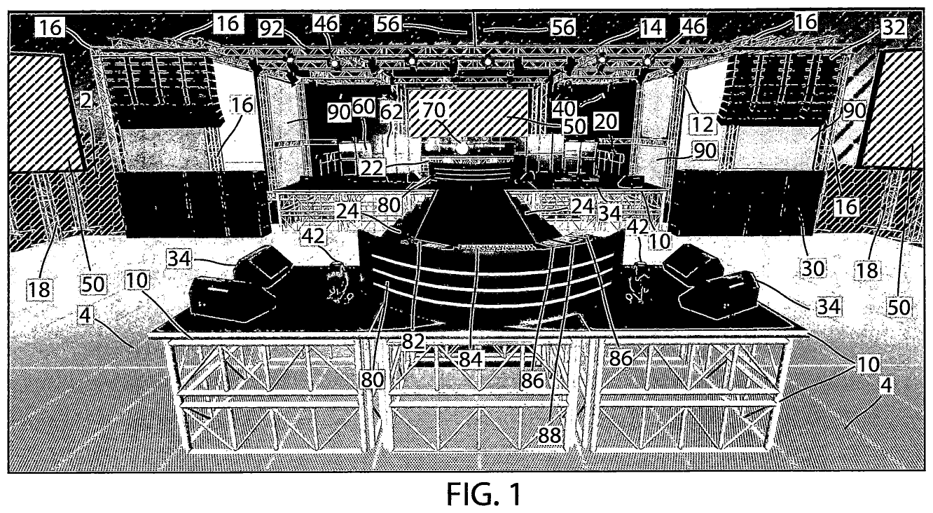

FIG. 1 a concert venue made by the miniature construction set of this invention utilizing the following miniature construction set components: Master Foundation Platform component 2; Floor Covering components 4; Stage Platform components 10; Stage Top Support components 12; Stage Top components 14; Speaker Support components 16; Video Monitor Support components 18; Stage Railing Components 20; Half Height Stage components 22; Stair components 24; Sub-woofer Speaker components 30; Full Range Speaker Array components 32; Floor Monitor components 34; Standard Light components 40; Moving Light components 42; Lighting Array components 46; Small Video Monitor components 50; Large Background Video Monitor components 56; Guitar Amplifier components 60; Bass Guitar Amplifier components 62; Drum Set components 70; DJ Booth components 80; DJ Booth Controller A components 82; DJ Booth Controllers B components 84; DJ Booth Controllers C components 86; DJ Booth Controllers D components 88; Curtain components 90; Stage Top Covering components 92.

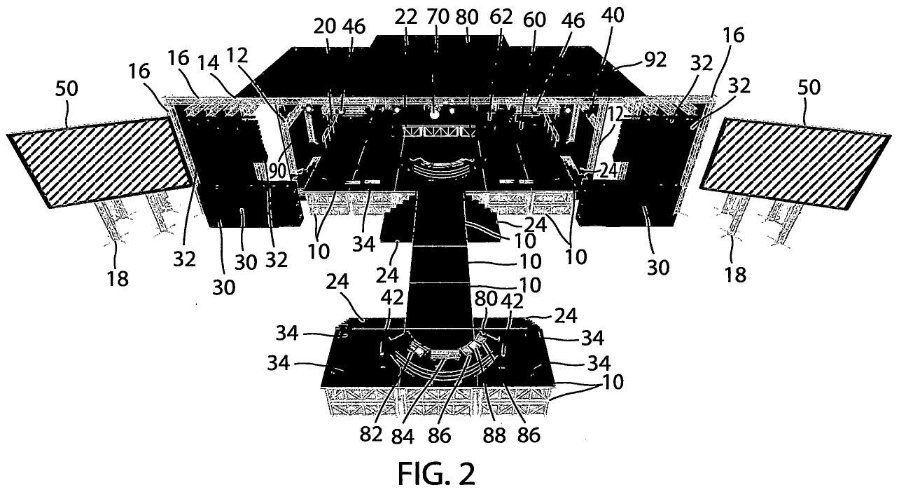

In FIG. 2 the concert venue shown in FIG. 1 is viewed from a different higher angle. The following miniature construction set components are shown: Stage components 10; Stage Top Support components 12; Stage Top components 14; Speaker Support components 16; Video Monitor Support components 18; Stage Railing Components 20; Half Height Stage components 22; Stair components 24; Sub-woofer Speaker components 30; Full Range Speaker Array components 32; Floor Monitor components 34; Standard Light components 40; Moving Light components 42; Lighting Array components 46; Small Video Monitor components 50; Guitar Amplifier components 60; Bass Guitar Amplifier components 62; Drum Set components 70; DJ Booth components 80; DJ Booth Controllers A components 82; DJ Booth Controllers B components 84; DJ Booth Controllers C components 86; DJ Booth Controllers D components 88; Curtain components 90; Stage Top Covering components 92.

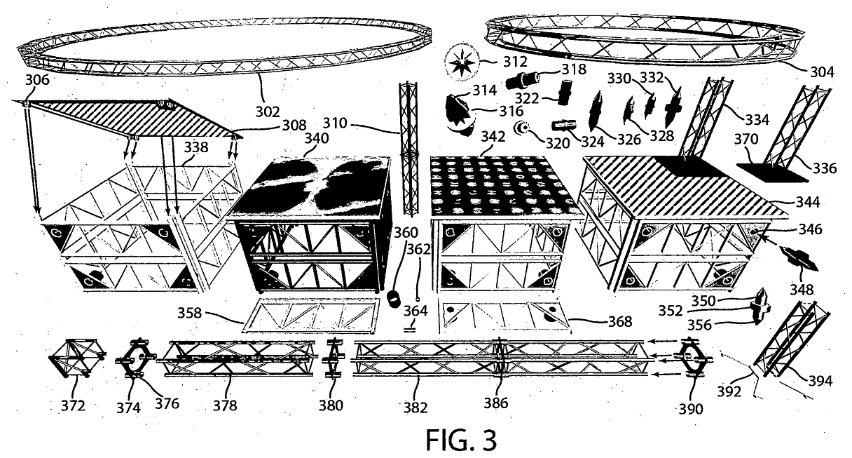

In FIG. 3 various miniature construction set components are shown.

A Large Round Truss Assembly component is shown as 302. A Small Round Truss Assembly component is shown as 304.

A Stage Platform component is created by connecting any number of Stage Frame Part components 358, 368, together using Stage Frame Connector components 364 and a Stage Platform Top component 308. When connecting the Stage Platform Top component 308 to the Assembled Stage Frame component 338, Stage Frame Connector components 364 are not necessary between the Stage Platform Top component and the Assembled Stage Frame components 338 because the Stage Platform Top component 308 has integrated Female Hardware Receptacles 306 (there are 8 of these on a removable Stage Platform Top component 308) as indicated by the arrows pointing to their male counter-parts on the Stage Frame component 338. Again, the entire removable Stage Platform Top component is shown as 308.

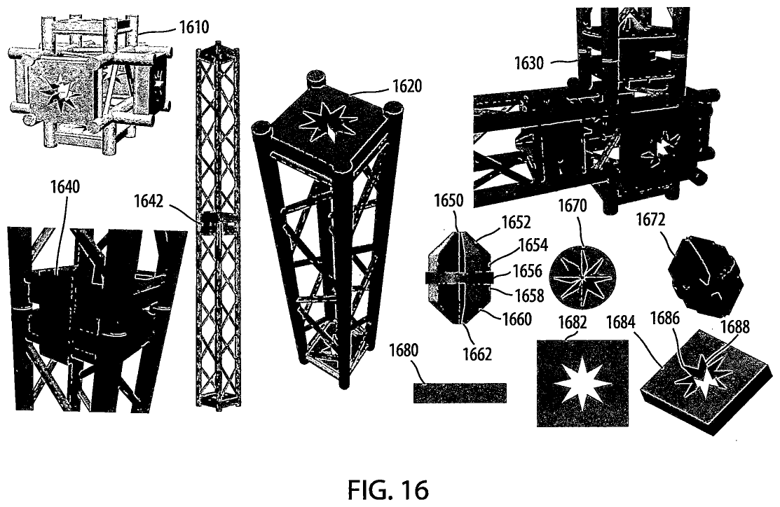

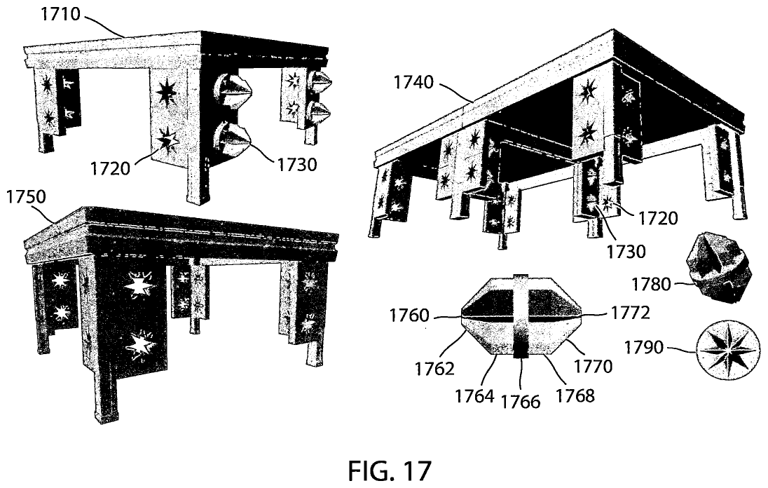

Regarding miniature construction set component connectors—312 is a unique Eight Pointed Star Female Receptacle which can be utilized as a female hardware connector for assembling the miniature construction set components. 314 is 312's male counterpart. 314 is a unique Eight Pointed Star Dual Male Hardware Connector that has an integrated spacer section 316 in the middle which is utilized to create the proper spacing between two components when connecting to those component's Female Hardware Receptacles 312. More detailed views of the unique Eight Pointed Star Connectors and some of their uses are shown in FIG. 16 and FIG. 17. [318 & 320] are Dual Male Connectors with a tapped hole in the middle which accept screws to secure them in place. [322 & 324] are Dual Male Connectors with no tapped hole in the middle but interface with their Female Hardware Counterpart Connectors in the same fashion that 314 interfaces with 312. [326, 328, 330, 332 & 348] are Dual Male Connectors with a spacer section similar to 316 in the middle that is utilized to create the proper spacing between two components when connecting to those component's female hardware connectors such as 346.

A Stage Top Foundation Support component 334 can come as a preassembled component or be put together with a Truss component 336 and Truss Foundation component 370. Another type of Stage Top Foundation Support can come as an assembled component or be put together with a Truss component 394 and Wide Truss Foundation component 392.

A Stage Top component such as that which was shown in “FIG. 1 Stage Top components 14” is not to be confused with a Stage Platform Top component such as that shown in “FIG. 3 Stage Top Platform component 308”. A Stage Top component such as that shown in “FIG. 1 Stage Top components 14” is the larger Truss Structure high above the stage, whereas a Stage Platform Top component such as that shown in “FIG. 3 Stage Platform Top component 308” is the top part of a Stage Platform component used for putting together the Stage Platforms themselves. Examples of Stage Platform components are “FIG. 1 Stage Platform components 10” as well as the various Stage Platform components shown in FIG. 3 and FIG. 17.

Continuing with the miniature construction set components shown in FIG. 3 (340, 342, 344) are all Stage Platform components and each can optionally have interchangeable tops or be a fixed factory constructed component. A Stage Platform component which is formed by a Stage Platform Top component 308 and the Assembled Stage Frame Parts 338 below it is shown with it's top lifted off. Stage Platform component 340 is a Stage Platform component with a Video Display Stage Platform Top as it's top and is connected to an HDMI or alternative video input as well as power on the back-side. Stage component 342 is an LED Stage Platform Top component with LEDs embedded in the Stage Platform Top component itself. The LEDs, inputs and power feeds used for the LED Stage Platform Top component and/or Interchangeable Stage Platform Top components such as 308 are the same type as those used in the other miniature construction set lighting components. Stage Platform Top component 344 is a Stage Platform Top component which can come with various materials as a Top Covering. Stage Platform Top component covering materials can be anything including but not limited to black rubber, metal, glass, etc., or even the loop material that is part of a “Hook and Loop” fastener system for easily and interchangeably moving miniature construction set components and accessories around while still providing a non-permanent means of fastening.

Any number of stage components may be joined together by utilizing any of the hardware connectors shown in the drawings or described in the specification. Most of these miniature construction set hardware connectors have semi-pointed ends to allow for easy alignment but not so sharp that they could easily damage the skin. A miniature construction set hardware connector like 348 is shown in an upright view showing it's Main Connection Section 350, Spacer Section 352 and Semi-Pointed Guide Section 356. Any of the Hardware Connectors may be used in a non-permanent fashion or glued together if desired. Connectors such as the unique Eight Pointed Star Connector (Female 312, Male 314) and shown with more detail in FIG. 16 & FIG. 17 have more surface area touching between the (Female 312 & Male 314) for any given depth of insertion and can provide more support. The unique Eight Pointed Star Connector (Female 312, Male 314) and shown with more detail in FIG. 16 & FIG. 17 is the preferred type of connector to use in all situations where it is practical. This can be even more advantageous when not using them with permanent glue or the clips shown in FIG. 16 (1640 & 1642) although you can certainly use both with the unique Eight Pointed Star Connectors (Female 312, Male 314). Other means of fastening Stage components and other miniature construction set Components together can include but is not limited to hook and loop fasteners, adhesive putty, various types of glue, hot melts, removable adhesive gel tapes, other double-sided tapes, and wax type adhesives. Robotic components including but not limited to Moving Lights, Moving Mirrors, and Moving Mirror Balls are discussed more fully later in the document and may use special hardware for more stable mounting.

338 is a Stage Frame Assembly which is made from Stage Frame components 358 & 368 along with Stage Frame Connectors 360, 362 & 364. A Stage Frame Assembly 338 and a Stage Platform Top component (308, 340, 342, 344) can be used to make any type of Stage Platform component (338+308, 338+340, 338+342, 338+344). 358 is a Basic Stage Frame component, 368 is an Integrated Stage Frame component with integrated female connectors 346 for attaching to other Stage components horizontally. The Stage component Frame Parts 358 and 368 can be stacked as high as desired vertically and are connected to to one another using Stage Frame Part Connectors 364, (362 end view), & (360 enlarged view). When connected to a Stage Platform Top component (308, 340, 342, 344) this allows for a stage platform of any height.

An assembled Truss Part 310 is shown in the vertical position and was assembled using two Truss Parts 378 and a Truss Connector 380.

The Multi Angle Truss Connectors 372 are available as [two, three, four, five and six] Angle Truss Connectors. A Two Angle Truss Connector 372 allows connections from two sides from two different angles whereas a Six Angle Truss Connector allows connections from six sides from six different angles. A Basic Truss Connector 380, 386 & 390 allows for connections between two Truss Parts along the same axis. Four hollow cylinders 376 (like 364) are bound together with a frame 374 to make the Basic Truss Connector 380. This makes it very quick and easy to connect two Standard Truss Parts 378 & 382 together. All of the connectors shown in FIG. 3 for connecting the various components and components can alternatively use the unique Eight Pointed Star Connectors (female 312, male 314) and shown with more detail in FIG. 16 instead of the other type of connectors shown in FIG. 3 (346, 348, 380, 386, 390) as their connector. The various components shown throughout this application may be manufactured using injection molding, 3D printing or any other manufacturing technique which may arise now or in the future for creating the parts.

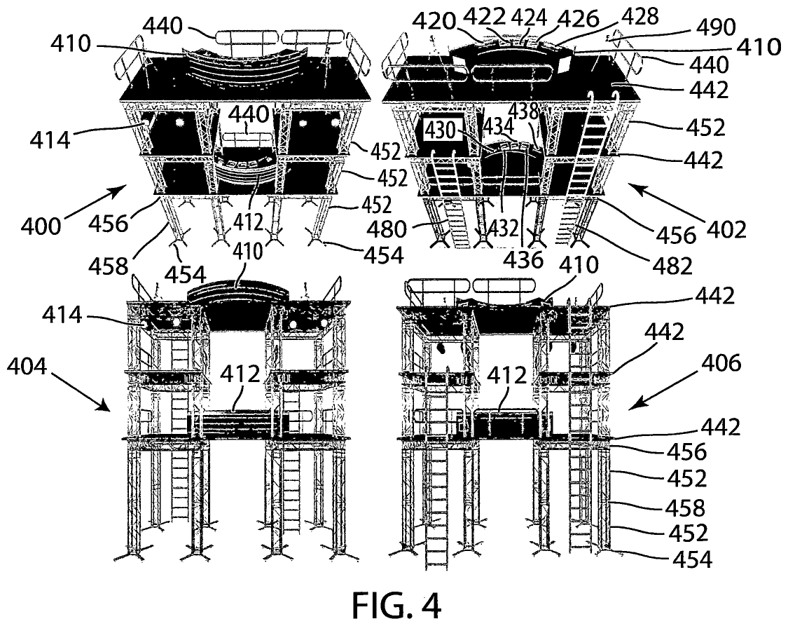

In FIG. 4 a Sound and Light Control Tower 400, 402, 404 & 406 is shown from various angles. The front view of the Sound and Light Control Tower from a higher perspective is shown as 400, the rear view of the Sound and Light Control Tower from a higher perspective is shown as 402, the Front View of the Sound and Light Control Tower from a lower perspective is shown as 404, and the Rear View of the Sound and Light Control Tower from a lower perspective is shown as 406.

The Sound and Light Control Tower is made by the miniature construction set of this invention utilizing the following miniature construction set components: Lighting Control Station 410, Sound Control Station 412, Lighting Controllers A 420; Lighting Controllers B 422; Lighting Controllers C 424; Lighting Controllers D 426; Lighting Controllers E 428; Sound Controllers A 430; Sound Controllers B 432; Sound Controllers C 434; Sound Controllers D 436; Sound Controllers E 438; Stage Railing Components 440; Control Tower Top components 442; Standard Truss Components 452; Standard Truss Connectors 458; Multi-Angled Truss Connectors 456; Wide Truss Foundation 454; Focused Beam Light components 414; Camera Tripod 490. All of the components can be manufactured using the unique Eight Pointed Star Connectors FIG. 3(Female 312, Male 314) as the assembly connectors and shown with more detail in FIG. 16 instead of any other type of connector shown in the drawings including but not limited to FIG. 4 (456 & 458) as their hardware connectors.

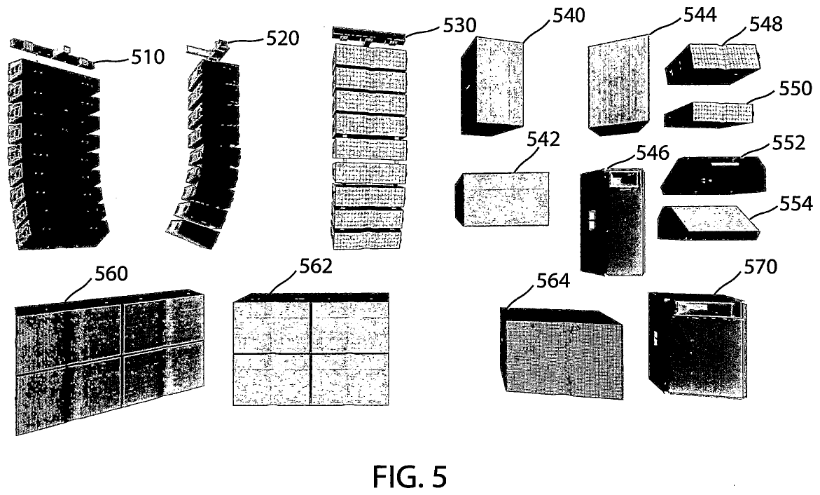

In FIG. 5 various Speaker Components are shown: Rear view of a Full Range Speaker Array 510; Side view of a Full Range Speaker Array 520; Front view of a Full Range Speaker Array 530; Vertical oriented Full Range Speaker 540; Horizontal oriented Full Range Speaker 542; Wedge Full Range Speaker 544; Full Range Speaker With Visible Horn 546; Full Range Speaker Array Element 548; Alternate Full Range Speaker Array

Element 550; Rear view of Wedge Style Stage Monitor 552; Rear view of Wedge Style Stage Monitor 552; Front view of Wedge Style Stage Monitor 554; Sub-Woofer Array 560; Alternate Sub-Woofer Array 562; Sub-Woofer Array Element 564; Alternate Full Range Speaker With Visible Horn 570. The Full Range Speaker Array 530 may be attached to Stage Top Truss using S-Hooks, or other means of connecting components as described in this specification.

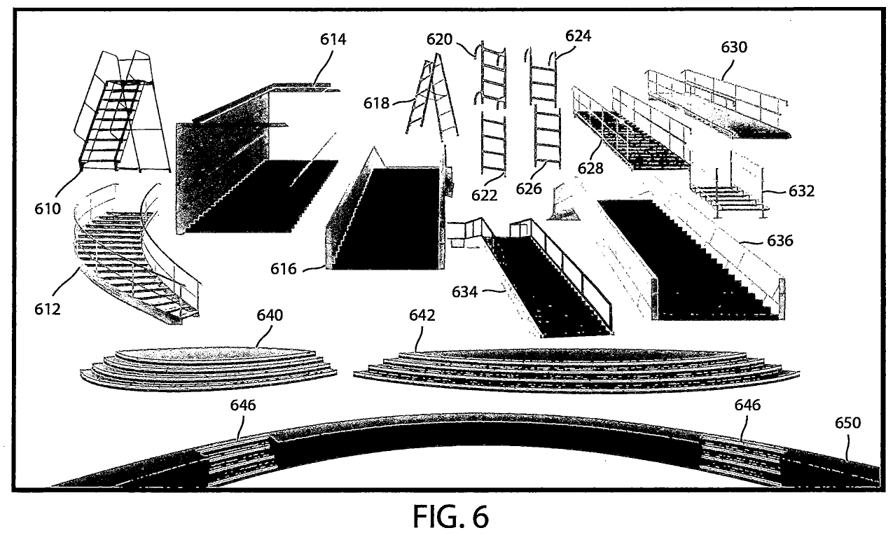

In FIG. 6 various Stair and Ladder components are shown: Movable Ladder With Platform 610; Standard Curved Stair 612; Lighted Stair With Surround Walls and Ceiling 614; Standard Lighted Stair 616; Step Ladder 618; Ladder With Hooks Style A 620; Extender For Ladder With Hooks Style A 622; Ladder With Hooks Style B 624; Extender For Ladder With Hooks Style B 626; Lighted Stair With Open Sides 628; Standard Ramp 630; Stage Stairs Style A 632; Lighted Stair With Clear Sides 634; Lighted Stair With Solid Sides 636; Lighted Stairs With Platform Size A 640; Lighted Stairs With Platform Size B 642; Dance Floor Lighted Stairs Style A 646; Dance Floor Surround With Integrated Lighted Stairs 650. All Lighted Stair styles can also be non-lighted. Lighted components may be powered by direct connections to fixed voltage sources or driven by the output of a microprocessor for individual LED control and lighting effects.

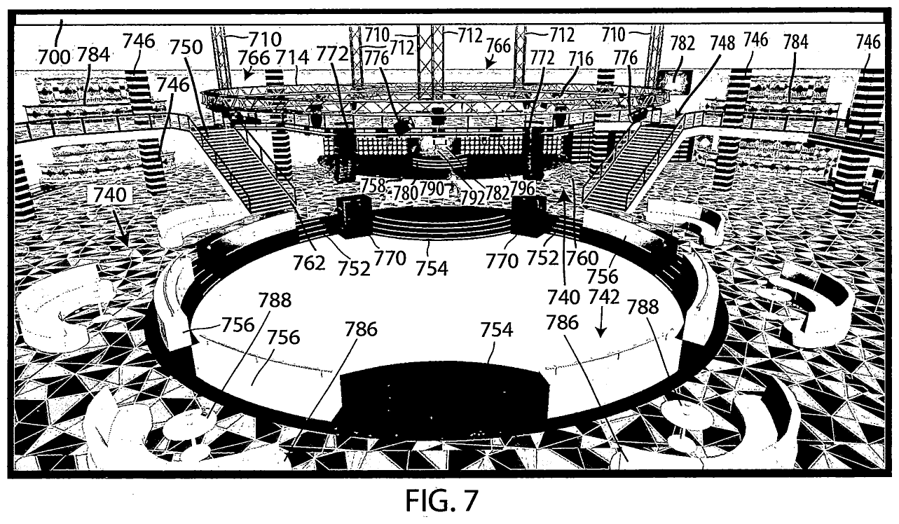

In FIG. 7 there is a perspective view of a Club which can be constructed using the following miniature construction set components: A Removable Clear Acrylic Top Cover 700 is used to provide support for hanging items which connect to Hanging Truss Bars 710(several) & 712(several) and allow for viewing into the Club from the Top View. Front views and other views into the Club can also be provide by using Clear Acrylic Outer Wall components 766 as the Outer Wall components 766 material or not using any Outer Wall components at all on certain sides or sections of walls as the Upper Areas can be fully supported by the Lighted Support Columns 746.

When used the optional Removable Clear Acrylic Top Cover 700 is supported by the Lighted Support Columns 746. The bottom side of Truss Bars 710(several) are shown connected to a Large Round Truss Component 714 and the bottom side of Truss Bars 712(several) are shown connected to a Small Round Truss Component 716. These hold Lights and other components. The top side of the Hanging Truss Bars 710 & 712 can be glued to the Removable Clear Acrylic Top Cover 700 or attached by other means. If only side and front views into the club are desired, then alternate materials may be used for a Top Covering support for Hanging Lights and other components such as a Mirror Ball.

A Main Floor Platform 740 serves as the foundation for the other components in the Club and can be provide as a continuous floor or optionally have a Sunken Dance Floor 742. Lighted Support Columns 746 are used to support Upper Floor components 748 which can come as an assembled Component or smaller sub-components. Lighted Support Columns 746 can also be stacked upwards to provide as high a support as desired for a Removable Clear Acrylic Top Cover 700 or other Top Covers. Large Lighted Stairs 750 and Small Lighted Stairs 752 are shown connecting the different levels. Large Lighted Stairs 750 are shown connecting the Main Floor Platform 740 with the Upper Floor components 748. Lighted Handrail 762 of Stairs 750 is shown. Small Lighted Stairs 752 are shown connecting the Main Floor Platform 740 with the Sunken Dance Floor 742. A Wide Lighted Platform With Stairs 754 is shown connecting the Main Floor Platform 740 with the Sunken Dance Floor 742. Dance Floor Surround Barriers 756 can be used to isolate areas of the Sunken Dance Floor 742. A Small Curved Stage Platform 758 has access to the Main Floor Platform 740 using the Small Standard Stage Stairs 760. Other components shown include: Sub-woofer Speaker components 770; Full Range Speaker Arrays 772; Light components 776—these can optionally be Standard or Moving Lights, DJ Booth 780; Video Monitors 782; Bar components 784 (which includes a bar, bar stools, bar racks, bottles); Couches 786; Tables 788; Figurines 790 & 792; LED Light Panels 796.

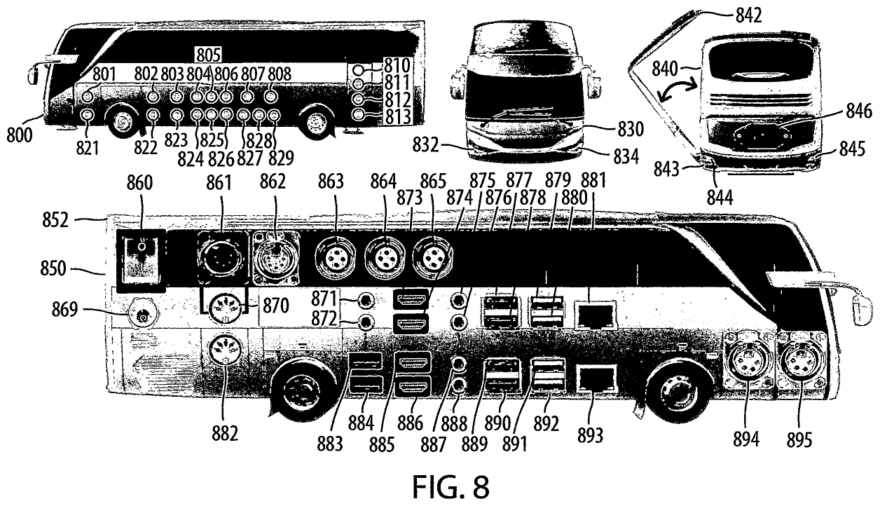

FIG. 8 shows a miniature construction set Power and Control Bus from various angles. The Left Side View of the Power and Control Bus 800 has numerous LEDs to show the state and/or activity of various functions and signals. They are assigned as follows: Power On 801; MIDI IN Activity 802; DMX IN Activity 803; Activity on Stereo Audio Input A 804; Activity on Stereo Audio Input B 805; Activity on Stereo Audio Input C 806; Robotics Control A Activity 807; Robotics Control B Activity 808; HDMI A Output Activity 810; HDMI B Output Activity 811; HDMI C Output Activity 812; HDMI D Output Activity 813; Power Condition 821; MIDI Out Activity 822; DMX Out Activity 823; Stereo Audio Output A activity 824; Stereo Audio Output B activity 825; Stereo Audio Output C activity 826; Lighting Control A Activity 827; Lighting Control B Activity 828; Lighting Control C Activity 829; the Front View of the Power and Control Bus 830; Left Head Light 834; Right Head Light 832; Rear View of the Power and Control Bus 840; Fold Out Left Side and Top of the Power and Control Bus 842—this gives access to the internal parts and wiring, hinge position 843 of the Fold Out Left Side and Top of the Power and Control Bus 842—this extends the length of the bus; Left Tail Light 844; Right Tail Light 845; AC Power In Receptacle 846; Right Side View of the Power and Control Bus 850; Top of the Power and Control Bus 852 that is part of the Fold Out Left Side and Top 842; Main Power Switch 860; DMX Input 861 (five pin connector)—this is for receiving control signals from a DMX Controller which can be used to control the various functions in the miniature construction set—this is connected to a serial port input on the internal computer system, DMX Output 862 (five pin connector)—this is connected to a serial port output from the internal computer system and can be used to control any of the various DMX devices available; Lighting Control Output A 863 (four pin connector)—this is connected to two separate and unique digital pins on the internal computer system which is mounted inside the Power and Control Bus 800 as well as to the positive and ground of the internal power supply—the output from this connector is fed to external addressable RGB LEDs with integrated drivers which are used throughout the entire miniature construction set system; Lighting Control Output B 864 (four pin connector) provides an additional lighting control output stream and it is connected to two separate and unique digital pins on the internal computer system as well as to the positive and ground of the internal power supply; Lighting Control Output C 865 (four pin connector) provides yet another lighting control output stream and it also is connected to two separate and unique digital pins on the internal computer system as well as to the positive and ground of the internal power supply; MIDI Input 870 can receive MIDI information from any external MIDI controller and be used to control the various functions in the miniature construction set—this is connected to a separate and unique serial port input on the internal computer system; Stereo Audio Input A 871—this is connected to two separate and unique analog inputs on the internal computer system; Stereo Audio Output A 872—this is connected to two separate and unique Outputs on the internal computer system; HDMI A Output 873; HDMI B Output 874; Stereo Audio Input B 875—this is connected to two separate and unique analog inputs on the internal computer system; Stereo Audio Output B 876—this is connected to two separate and unique audio outputs on the internal computer system; USB 2 port A 877; USB 2 port B 878; USB 3 port C 879; USB 3 port D 880; internal computer system Gigabit Ethernet Connector A 881; MIDI Output 882 can send MIDI information to any external MIDI device—this is connected to a separate and unique serial port output on the internal computer system; USB 3 Port E 883; USB 3 Port F 884; HDMI C Output 885; HDMI D Output 886; Stereo Audio Input C 887—this is connected to two separate and unique analog inputs on the internal computer system; Stereo Audio Output C 888—this is connected to two separate and unique audio outputs on the internal computer system; USB 2 port G 889; USB 2 port H 890; USB 3 port I 891; USB 3 port J 892; Gigabit Ethernet Connector B 893; Robotics Control Output A 894 (four pin XLR connector with I2C and Power)—this is connected to (SDA) and (SCL) internal computer system which is mounted inside the Power and Control Bus 800 as well as to the positive and ground of the internal power supply—the output from this connector is fed to an external RockersAndStage Robotics Interface Board which has a 16-Channel 12-bit PWM/Servo Driver with an I2C interface—using only two pins from the internal computer system this can control 16 free-running PWM outputs—up to 62 breakouts can be chained to control up to 992 PWM outputs; Robotics Control Output B 895 (four pin XLR connector with I2C and Power)—this is connected to (SDA1) and (SCL1) on the internal computer system as well as to the positive and ground of the internal power supply—the output from this connector is fed to an additional external miniature construction set Robotics Interface Board which adds an additional 16-Channel 12-bit PWM/Servo Driver with an I2C interface—again using only two pins from the internal computer system this can control an additional 16 free-running PWM outputs —up to 62 breakouts can be chained to control up to an additional 992 PWM outputs,

Most of the LEDs used in the miniature construction set are Addressable RGB LEDs with Integrated Drivers. Hundreds of these can be connected in series and controlled from just two pins on the internal computer system which is mounted inside the Power and Control Bus 800. Optionally an external computer and interface box with some or all of the connections that are shown on the Power and Control Bus 800 can be used in place of the internal computer system which is mounted inside the Power and Control Bus 800. All of the Addressable RGB LEDs with Integrated Drivers in the entire system can change color and intensity incredibly fast and be programmed to create any type of lighting effect desired.

The control signals are provided by the main computer and a number of sub-assemblies which together form the overall computer system. For example a single board microprocessor sub-assembly with sixteen analog inputs can provide parallel processing of the incoming signals from it's sixteen analog inputs and provide the analyzed data to the master computer for integrated processing. Other microprocessor sub-assembly boards can be used for lighting control signals, audio outputs, robotics control signals, video playback, or any of the other functions described in this specification. Together any number of these sub-assemblies along with the main computer are the Computer System for the miniature construction set.

Other wired or wireless devices such as Head Trackers, Joy Sticks and almost anything that can output a control signal can be used as input devices to the miniature construction set and be used to control almost anything that is controllable in the system.

Different Power and Control vehicles or structures such as a Truck, Small Structure or even a Miniature Road Case can be fitted with any number of the connectors and indicators shown in FIG. 8 to provide alternative Power and Control size and functionality.

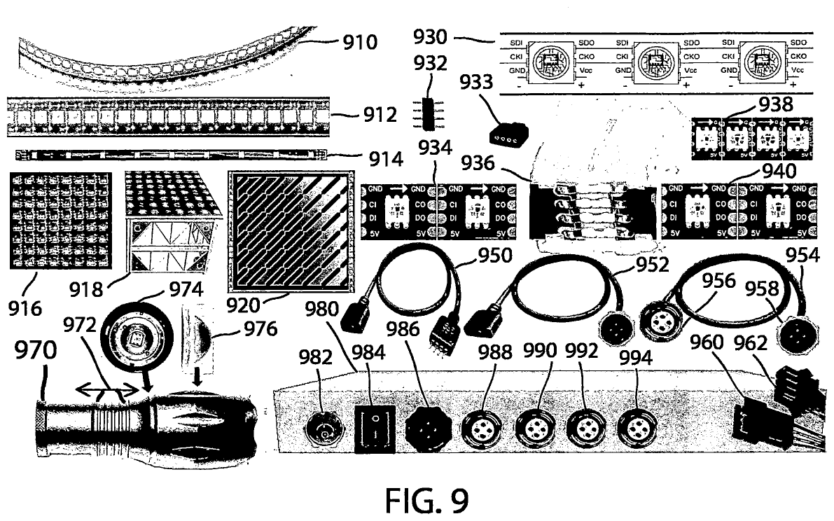

FIG. 9 shows a number of Lighting Components which are part of the miniature construction set. They are as follows: High Density LED Strip A 910; High Density LED Strip B 912; Low Density LED Strip 914; LED Matrix type A 916; Stage Platform with LED Matrix 918; Stage Platform Top 920 with medium density LED strip lights running up the left and right sides (these can be any density and/or width and run as any length of continuous strips across any number of multiple Stage Platforms or other components) Electroluminescent Wire is shown as the lines across the top and bottom (these can be any width or shape and run as any length across any number of multiple Stage Platforms or other components); Schematic drawing of multiple addressable LEDs wired in series 930; Four Pin Dual Male Type A LED Strip Inter-connector 932; Four Pin Female Type A LED Strip Connector 933 (these may be attached to wires which are connected to the LED strips or be connected directly to the end of LED Strips themselves as is shown in 914 and may come in various housing types); Medium Density LED Strip 934 showing two LEDs; LED strip Solder-less Connector 936—this is used to connect two LED Strips such as 934 and 940 together; another Medium Density LED Strip 940 showing two LEDs—this instance is for illustrating the use of the LED Strip Solder-less Connector 936; High Density LED Strip 938 showing four LEDs; Four Pin Dual Female Type A Extension Cable 950 shown with a Four Pin Dual Male Type A LED Strip Inter-Connector 932 inserted into one end on the right side these are available in various lengths; Four Pin LED inter-connector cable 952 with a Four Pin Female Type A LED Strip Connector 933 on one end and a Four Pin Male Type D LED Strip Connector 958 on the other end—these are available in various lengths; Four Pin LED inter-connector cable 954 with a Four Pin Female Type D LED Strip Connector 956 on one end and a Four Pin Male Type D LED Strip Connector 958 on the other end—these are available in various lengths and are the type of cable used to connect the Power And Control Bus shown in FIG. 8 to the LED Power Booster/Splitter 980 in FIG. 9 as well as for extending this type of cable; Four Pin Female Type D LED Strip Connector 956; Four Pin Male Type D LED Strip Connector 958; Four Pin Male Type B LED Strip Connector 960; Four Pin Female Type B LED Strip Connector 962; Focus-able Spot Light Type A 970; Adjustable Focus Mechanism 972; Internally center mounted Addressable RGB LED 974 is mounted in the smaller diameter portion of the Spot Light housing with the light shining toward the lens; Focus-able Lens 976 is center mounted in the larger diameter portion of the Spot Light housing with the curve facing outward in the same direction as the light. Moving the larger diameter portion of the Spot Light housing relative to the smaller diameter portion of the Spot Light housing changes the focus, moving them away from one another makes the light pattern smaller but more intense; LED Power Booster/Splitter 980—can be used to add additional power to the same serial chain of LEDs and thus drive longer strings of LEDs and additionally it can provide splits to drive multiple strings of LEDs with the understanding that these types of splits will each carry the same signal and pattern; Additional DC Power Input 982 this should be 5V DC at 10 Amps; Lighted Power Switch 984; Power Booster/Splitter Input 986; Power Booster/Splitter Output A 988; Power Booster/Splitter Output B 990; Power Booster/Splitter Output C 992; Power Booster/Splitter Output D 994—units with more Splitter Outputs are optional.

All of the LEDs are addressable RGB LEDs with integrated drivers. Hundreds of these can be connected in series and controlled from just two pins on the computer system, multiple sets of pins can be used for multiple output streams. Every addressable LED in the entire system can change Color and Intensity incredibly fast and be programmed to create any type of Lighting Effect desired. It should be noted that any LED strips that are connected to the same splitter's outputs will carry the same LED Color and Intensity assignments—so this should be accounted for in the desired use of splitters. In FIG. 9 item 920 the Electroluminescent Wire mentioned is driven by it's own power supply which can be controlled by the computer system sending a digital signal to a relay which turns the Electroluminescent Wire's power supply. Despite the name “Electroluminescent Wire” we use it in a broader sense to include all similar devices such as “Electroluminescent Panels” and all can be driven and controlled in the same fashion with the computer system sending a digital signal to a relay which turns on the “Electroluminescent” device's Power supply. These “Electroluminescent Panels” can be any shape.

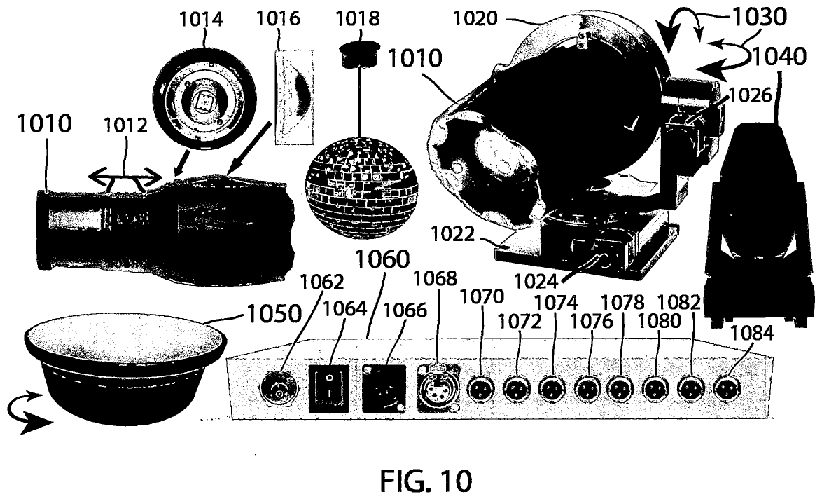

FIG. 10 shows Motorized Focus-able Spotlights, a Motorized Mirror ball, a Motorized Rotating Platform and a remote controllable miniature construction set Robotics Interface which are part of the miniature construction set. The miniature construction set components shown in FIG. 10 are as follows:

Motorized Focus-able Spot Light Type A; Motorized Focus Mechanism 1012—the motor is mounted internally and is driven by one of the outputs from the remote controllable Robotics Interface 1060; an internally center mounted addressable RGB LED 1014 is mounted in the smaller diameter portion of the Spot Light housing with the light shining toward the lens—it is driven by one of the Lighting Control Output such as A 863 (four pin connector) in FIG. 8 and may be inserted at any point in that serial stream; Focus-able Lens 1016 is center mounted in the larger diameter portion of the Spot Light housing with the curved part facing outward in the same direction that the light from the LED is pointing toward—when the internal motor moves the larger diameter portion of the Spot Light housing relative to the smaller diameter portion of the Spot Light housing it changes the focus—moving them away from one another makes the light pattern smaller but more intense while moving them toward one another makes the light pattern larger and less intense; Motorized Mirror Ball 1018—it is driven by one of the outputs from the remote controllable Robotics Interface; Moving Light type A XY Position Pointer 1020 is for use with the (Motorized Focus-able Spot Light type MSL-A-1M 1010 or similar Spot Lights) the Spot Light XY Position Pointer Type SL-PP-A 1020 has a Servo Motor for moving the Moving Light type A along the X axis 1024 and a Servo Motor for Moving Light type A along the Y axis 1026 the directions of these motions is also indicated by the curved arrows of 1030, the Moving Light type A XY Position Pointer is mounted with it's Mounting Plate 1022; Moving Light type B 1040 has both a Motorized Spot Light similar to 1010 but is much smaller and an XY Position Pointer similar to 1020 but also much smaller—these are attached together and mounted inside of the super miniature Moving Light type B 1040's housing—the internal light source is also an addressable RGB LED which is connected in series to one of the Lighting Control Outputs from the Power and Control Bus shown in FIG. 8—there is a four wire input to the LED and a four wire output from the LED to allow it to be placed in the serial chain without causing the chain to terminate—additionally each of the three motors (one for focus—one for X control & one for Y control) have three wire connectors to unique Servo Driver outputs from a miniature construction set Robotics Interface—an alternative version of a Super Miniature Moving Spot Light can have built-in servo drivers; A Motorized Rotating Pedestal/Turntable 1050 is used for spinning objects such as a Figurine; miniature construction set Robotics Interface 1060 has an internally mounted 16-Channel 12-bit PWM/Servo Driver with an I2C interface—using only two pins from the computer system this can control 16 free-running PWM outputs—up to 62 breakouts can be chained to control up to 992 PWM outputs; the miniature construction set Robotics Interface has it's own DC Power Input 1062 for additional power—5 VDC; Lighted Power Switch 1064; Input connector 1066—(four pin XLR connector with I2C and Power)—this is connected to an (SDA) and (SCL) on the computer system mounted inside the Power and Control Bus as shown in FIG. 8 as well as to the positive and ground of the internal power supply on the Power and Control Bus; an I2C Output Connector 1068 is for chaining additional miniature construction set Robotics Interface's; Servo Driver Output A 1070; Servo Driver Output B 1072; Servo Driver Output C 1074; Servo Driver Output D 1076; Servo Driver Output E 1078; Servo Driver Output F 1080; Servo Driver Output G 1082; Servo Driver Output H 1084; There are an additional 8 Servo Driver Outputs on the back side of the miniature construction set Robotics Interface.

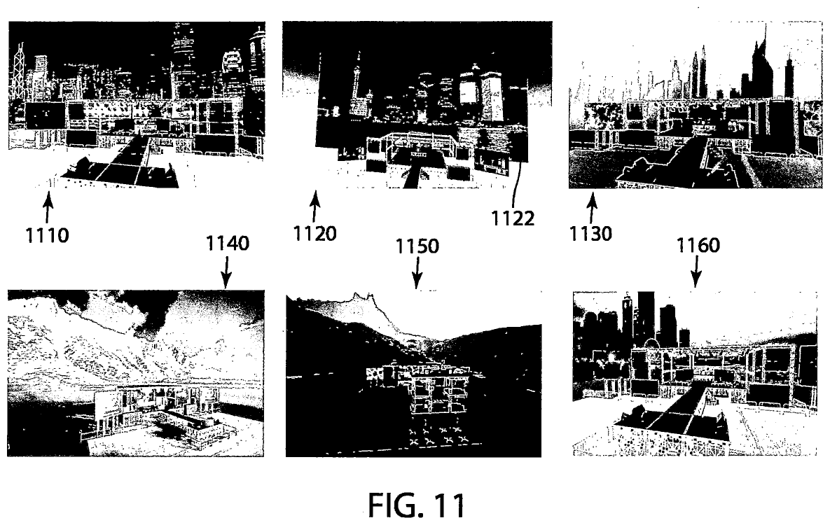

FIG. 11 shows a number of Dioramas which can be created using large Video Monitors and Projectors as part of the miniature construction set, these include both 2D and 3D Video Monitors and Projectors. The following Dioramas are shown: A Diorama of an Outdoor Concert 1110 where a Video Projector creates the background on a wall, screen or other surface; A Diorama of an Outdoor Concert 1120 where a Large Video Monitor 1122 (which can be any size available) creates the background, there can also be multiple monitors used at any desired angles such as two monitors at ninety degree angles in the corner of a room or three monitors at forty-five degree angles to one another to create a wrap around for the background (the two smaller monitors shown in the foreground to either side of the stage can also be any size available); A Diorama of an Outdoor Concert 1130 where a Large Curved Video Monitor creates the background; A Diorama of an Outdoor Concert 1140 where a miniature construction set Scenic (a foam and/or plastic shell terrain with 3D elements, which can be put together from multi-parts) is used as the terrain including the ground foundation and background mountains and sky; A Diorama of an Outdoor Concert 1150 where a miniature construction set Scenic (a foam and/or plastic shell terrain with 3D elements, which can be put together from multi-parts) is used as the foreground terrain including the ground foundation and foothills and a Large Video Monitor is used for the background mountains and sky; A Diorama of an Outdoor Concert 1160 where a Large Glasses-Free 3D Monitor (which can be any size available) creates a background with elements that appear as 3D objects which stand out from the background—such as the Ferris Wheel.

The Monitors are driven by the HDMI outputs from the computer system, additional computer, tablet, smartphone or similar unit and controlled by signals from the computer system as described in the FIG. 8 section of this document.

Backgrounds may be also be created from alternate sources including but not limited to 3D hologram fan projectors, printed images or painted walls of any size and even an entire background of physical objects or combination of physical objects with any of the background methods described in this document. For instance placing a 3D model of a skyscraper between the background and the stage in 1110 would give it a more dimensional appearance.

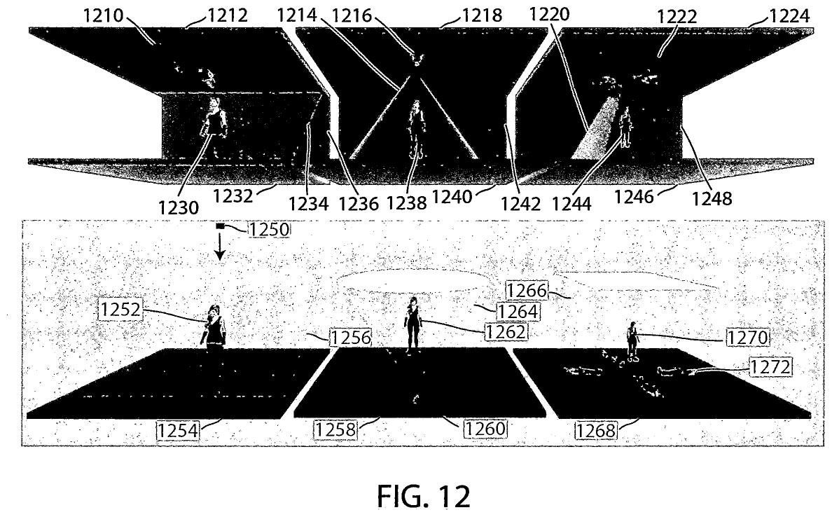

FIG. 12 shows various holographic stages and displays which can be incorporated into the miniature construction set. The following holographic components and methods are shown: The holographic Image 1230 is created with a video monitor 1212 mounted above the holographic image and emitting the image shown as 1210, it is reflected off an optical beam splitter mirror 1234, which in this case is in the shape of a flat surface, the material used in this method can be beam splitter glass or high quality acrylic, with the beam splitter glass providing the highest quality image, this glass is mounted at a forty-five degree angle relative to the video monitor; The holographic image 1238 is created with a video monitor 1218 mounted above the holographic image and emitting the image shown as 1216, it is reflected off an optical beam splitter mirror, which in this case is in the shape of a cone 1214, the material used in this method is usually high quality acrylic with beam splitter glass providing a more expensive but higher quality option, the faces of the cone should be at a forty-five degree angle relative to the video monitor (although it can work at different angles)—this method requires that a re-mapping of the pixels be performed to create a warped image that will look correct when reflected as a holographic image from the curved surface; The holographic image 1244 is created with a video monitor 1224 mounted above the holographic image and emitting the image shown as 1222, that is reflected off an optical beam splitter mirror, which in this case is in the shape of a pyramid 1220, the material used in this method is usually high quality acrylic with beam splitter glass providing a more expensive but higher quality option, this method requires that the image to be emitted is transformed into four separate images where each will appear above each face of the pyramid and oriented as shown in 1222;

The holographic image 1252 is created with a digital video projector 1250 mounted above the holographic image and emitting the image shown in the reflected image 1252, it is reflected off an optical beam splitter mirror 1256, which in this case is in the shape of a flat surface, the material used in this method can be beam splitter glass or high quality acrylic, with the beam splitter glass providing the highest quality image; The holographic image 1262 is created with a video monitor 1258 mounted below the holographic image and emitting the image shown as 1260, it is reflected off an optical beam splitter mirror, which in this case is in the shape of a downward pointing cone 1264 with it's point flattened to provide a means balance and/or mounting, the material used in this method is usually high quality acrylic with beam splitter glass providing a more expensive but higher quality option, the faces of the cone should be at a forty-five degree angle relative to the video monitor (although it can work at different angles)—this method requires that a re-mapping of the pixels be performed to create a warped image that will look correct when reflected as a holographic image from the curved surface; The holographic image 1270 is created with a video monitor 1268 mounted below the holographic image and emitting the image shown as 1272, that is reflected off an optical beam splitter mirror, which in this case is in the shape of a downward pointing pyramid 1266 with it's point flattened to provide a means balance and/or mounting, the material used in this method is usually high quality acrylic with beam splitter glass providing a more expensive but higher quality option, this method requires that the image to be emitted is transformed into four separate images where each will appear above each face of the pyramid and oriented as shown in 1272.

In general the method shown for creating the holographic image 1252 can produce the largest and highest quality holographic image, provided that the video projector is of sufficient intensity and quality.

All of the holographic Image methods shown are based on the principle often referred to as “Peppers Ghost”. The advantages and improvements available when using these with the miniature construction set is that a much more dimensional and believable event environment is achieved when incorporating and placing the various miniature construction set components in and around the holographic stages. Wired or wireless head trackers and other types of directional devices can be used as input devices to the miniature construction set's computer system and used to control the viewing angle of the holographic images.

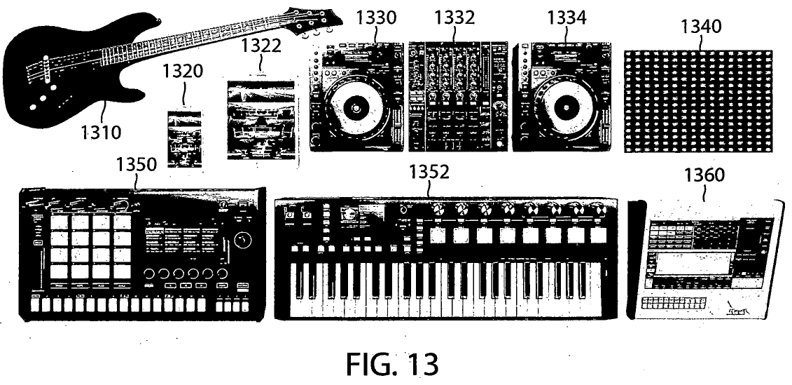

FIG. 13 shows a number of MIDI and DMX Controllers which can be used with the miniature construction set. The following MIDI and DMX Controllers are shown: A guitar with a MIDI Output 1310; A Smartphone running software that can output MIDI 1320; A Tablet Computer or any type of Computer running software that can output MIDI 1322; A DJ Controller Section A 1330 that is capable of outputting MIDI from it's various controls; A DJ Controller Section B 1332 that is capable of outputting MIDI from it's various controls; A DJ Controller Section C 1334 that is capable of outputting MIDI from it's various controls; A sixteen by sixteen Matrix Controller 1340 with MIDI output; A MIDI Control Station 1350, that is capable of outputting MIDI from it's various control knobs and Trigger Pads; A MIDI Keyboard Controller 1352, that is capable of outputting MIDI from it's various keys, controls and trigger pads; A DMX Controller 1360.

MIDI is an acronym for “Musical Instrument Digital Interface” it is a technical standard that describes a communications protocol, digital interface, and electrical connectors that connect a wide variety of electronic musical instruments, computers, and related audio devices for playing, editing, and recording music. A single MIDI link through a MIDI cable can carry up to sixteen channels of information, each of which can be routed to a separate device or instrument. This could be sixteen different digital instruments, for example. MIDI carries event messages; data that specify the instructions for music, including a note's notation, pitch, velocity (which is heard typically as loudness or softness of volume); vibrato; panning to the right or left of stereo; and clock signals (which set tempo). When a musician plays a MIDI instrument, all of the key presses, button presses, knob turns and slider changes are converted into MIDI data.

DMX known also as DMX512 is a standard for digital communication networks that are commonly used to control stage lighting and effects. It was originally intended as a standardized method for controlling light dimmers, which, prior to DMX512, had employed various incompatible proprietary protocols. It soon became the primary method for linking controllers (such as a lighting console) to dimmers and special effects devices such as fog machines and intelligent lights. DMX has also expanded to uses in non-theatrical interior and architectural lighting, at scales ranging from strings of Christmas lights to electronic billboards and stadium or arena concerts. DMX can now be used to control almost anything.

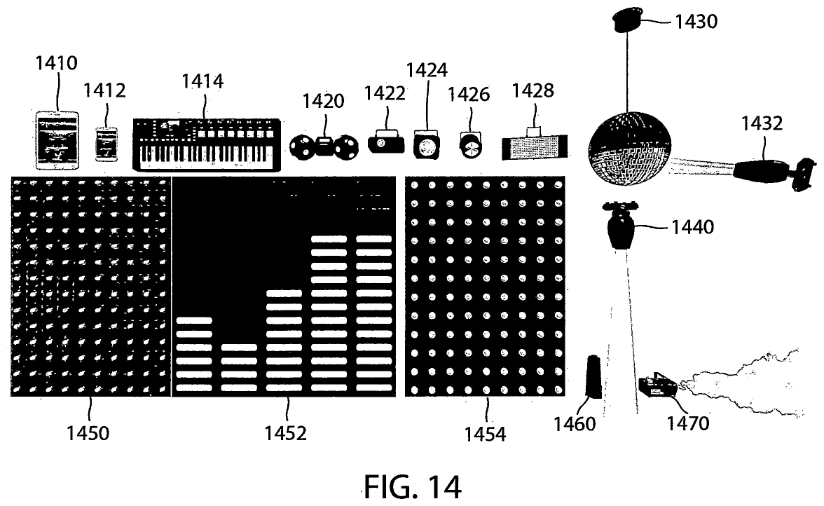

FIG. 14 shows a number of controllable MIDI and DMX components which can be used with the miniature construction set. The following controllable MIDI and DMX components are shown: A Tablet Computer 1410 that is running software that can be controlled by MIDI—this can be any kind of computer; A Smart Phone 1412 that is running software that can be controlled by MIDI—this can be any kind of Smart Phone; A MIDI Keyboard 1414 with a built-in sound generator; A DMX Controlled Rotary Light 1420; A DMX Controlled Laser Light 1422; A DMX Controlled Multicolored Fill Light Type A 1424; A DMX Controlled Multicolored Fill Light Type B 1426; A DMX Controlled Multicolored Fill Light Array 1428; A DMX Controlled Motorized Mirror Ball 1430; A DMX Controlled Mirror Ball Spotlight 1432; A DMX Controlled Multi-color Moving Head Spotlight 1440; A DMX Controlled Large Wall Panel with Multi-color Lights—Type A 1450; A DMX Controlled Large Wall Panel with Multi-color Lights—Type B 1452; A DMX Controlled Large Wall Panel with Multi-color Lights—Type C 1454; A DMX Controlled Professional Stage Effect 1460; A DMX Controlled Fog machine 1470.

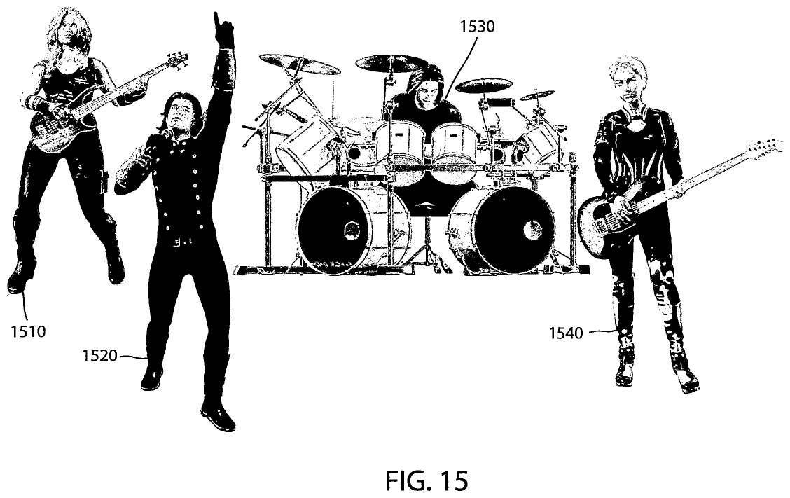

FIG. 15 shows a number of figurines which are part of the miniature construction set. The following figurines are shown: Figurine of a female Bass Guitar Player with Bass Guitar 1510; Figurine of a male Singer with Microphone 1520; Figurine of a male Drummer with Drum Kit 1530; Figurine of a female Guitar Player with Guitar 1540.

FIG. 16 shows a number of Components which utilize the miniature construction set's Eight Pointed Star Connectors as well as detailed drawings of the connectors themselves. A Dual Male Eight Pointed Star Hardware Connector (1670, 1672) in conjunction with it's Eight Pointed Star Female Receptacle 1682 are the preferred hardware connectors for connecting most of the miniature construction set's components for those components where it is practical to use them. The Eight Pointed Star Dual Male Hardware Connector has up to seven sections (1650, 1652, 1654, 1656, 1658, 1660, 1662), tip section A 1650, alignment section A 1652, primary contact section A 1654, spacer section 1656, primary contact section B 1658, alignment section B 1660, tip section B 1652. The spacer section 1656 is utilized to create the proper spacing between two components when connecting to those component's Female Hardware Receptacles 1682 as shown in 1630. The dimensions of each section may be adjusted for specific needs. 1670 is a top view of the Eight Pointed Star Dual Male Hardware Connector 1672. 1682 is the top view of the Eight Pointed Star Female Receptacle. 1680 is the side view of the Eight Pointed Star Female Receptacle showing it's depth that is visible in 1688. 1684 is an angled view of the Eight Pointed Star Female Receptacle. 1686 shows the outer points of the female receptacle's cutout and 1688 shows the female receptacle's depth which was not visible in 1680.

Female Hardware Receptacles can be integrated as a part of most components. Examples of truss components with integrated female hardware receptacles include but are not limited to a Six Sided Truss Component 1610, a Long Truss Component 1620 and a multi-truss assembly 1630 which is constructed using 1610, 1620 and 1672 components. A Component Clip 1640 may be used for additional strength. 1642 shows two truss components that are stacked on top of one another and attached using the Eight Pointed Star Dual Male Hardware Connector 1672 and also use the Component Clip 1640 for additional strength.

FIG. 17 shows a number of Stage Platform components which utilize the miniature construction set Eight Pointed Star Dual Male Hardware Connector 1780 in conjunction with it's Eight Pointed Star Female Receptacle 1720. The Eight Pointed Star Dual Male Hardware Connector 1780 has an integrated spacer section 1766 in the middle which is utilized to create the proper spacing between two components when connecting to those component's Female Hardware Receptacles 1720 which are integrated into the components. 1740 shows two Stage Platform components 1710 connected with this proper spacing.

The sections of the Eight Pointed Star Dual Male Hardware Connector 1780 are shown as the tip section A 1760, the alignment section A 1762, the primary contact section A 1764, the spacer section 1766, the primary contact section B 1768, the alignment section B 1770, and the tip section B 1772. A person skilled in the art will understand that the specific dimensions, relative sizes and relative angles of these sections may be adjusted without departing from the spirit of the invention. 1790 shows an end view of the Eight Pointed Star Dual Male Hardware Connector 1780. The Eight Pointed Star Dual Male Hardware Connector 1780 in conjunction with it's Eight Pointed Star Female Receptacle 1720 provides a unique connector combination that is very easy to assemble, has greater surface area contact for greater holding power and built-in spacer and alignment sections for faster and more accurate assembly.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the system is not limited to the embodiments shown, but is to be accorded the widest scope consistent with the principles and features disclosed herein.

The present invention is a miniature construction set of assembled components, component kits, individual component parts, figurines and accessories for quickly creating miniature, semi-realistic to realistic looking entertainment industry event venues as well as futuristic entertainment venues of all kinds including but not limited to concerts, clubs, TV show sets, sporting events and other events with real-time interactive elements. The type of assembled components that are part of the miniature construction set include but are not limited to unique Eight Pointed Star Connectors, stage platforms, stage foundations, stage top, stage top supports, sound systems, video screens, holographic stages, standard lights, addressable per LED lights, DMX lighting, lighting patchbays, fiber optic lighting, special effects, security barriers, stairs, curtains, dance floors, control booths, master controllers, power supplies, TV show accessories, decorations, truss of all types, electroluminescent wire and other accessories in order to create the type of venues that are typical in the target venue. All of the components listed can come in kit form or as assembled components. Master Kits can be made available for different types of venues or custom ordered to a customers specific needs. In addition to specific lighting components, each type of the other components can come in lighted and non-lighted versions in order to make the components available at various price points and make the construction sets more customizable. For example a number of Stage components that are unlighted versions might be topped with Light components, electroluminescent wire, fiber optics or other components on any or all of their sides. All of the items shown in the drawings are to be considered part of the Master miniature construction set as well as any items mentioned in this document that are not specifically shown in the drawings. The truss components, stage components and most of the other items may be manufactured using the injection moulding process, 3D printers or other manufacturing processes as they become available.

The lighted components can be controlled in real-time allowing each individual LED to be any color and intensity. The change in color and intensity can happen sufficiently fast enough to create all kinds patterns, sweeps and even video images on properly spaced LEDs. components with lighting can have their own controllers or can be driven by master controller components for system wide control. The miniature construction set Power and Control Bus shown in FIG. 8 is an example of a Master Controller component. The LED control signals are generated by the miniature construction set's computer system. In addition to the general program effects and lighting assignments, where each LED is assigned a specific position in the lighting control signal streams, any pixel position can be changed to another pixel position in real-time through a remapping function which itself can also be changed in real-time through a miniature construction set Master Controller programmer running on a computer or smart phone.

The LEDs used in the preferred embodiment are addressable RGB LEDs with Integrated Drivers. These are available in various physical sizes. Other LED options are also available.

In addition to lighting options each type of component or accessory can come with decals, be custom painted or have other surface treatments. The Master Control components themselves may be controlled in real-time through USB, MIDI and/or DMX connections and protocols, and may be wired or wireless. Real-time Controller components can generate these signals or existing controllers, computers and smartphones can be used for this purpose.

Real-time Controller components can be configured to interactively provide real-time control by utilizing force sensing resistors, capacitance sensors, infrared sensors, lidar, presence sensors, cameras, microphones, audio files, signals from a computer or smart phone and any other sensor capable of outputting electrical signals.

Optional lighting patchbay components can be used for routing the main lighting control signals from the Master Control components to the various components.

Platform components are available with various coverings, colors and textures. When the Platform component's covering is the loop side of a hook and loop fastener it provides a great way to mount the components to a master ground terrain foundation for easily moving the venue.

Physical attachment of the components to each other and other accessories can be by a number of means including but not limited to: The Eight Pointed Star Dual Male Hardware Connector (1730, 1780, 1790) in conjunction with it's Eight Pointed Star Female Receptacle (1720), hook and loop fasteners—which can be transparent or opaque; component array connectors; magnets; and other traditional means. Non-adhesive and adhesive options are also available for connecting the various components and accessories.

The components and construction sets can also be made in various scales and be packaged as complete sets for creating specific entertainment event venues.

Entire pre-fabricated venues which are made from the miniature construction set or replicas can be made and sold as collectibles at various scales.

Each set can optionally include figurines which are appropriate for the target venue, scale and audience.

### DETAILED DESCRIPTION OF A PREFERRED EMBODIMENT

A prefer embodiment of the present invention would include all of the components shown in FIG. 1 through FIG. 10 with a sufficient quantity of each item so that one could create: the entire concert venue shown in FIG. 1; the entire club venue shown in FIG. 7; the diorama shown as 1120 in FIG. 11; the Hologram shown as 1230 and components required for creating it as shown in FIG. 12. It would also include a miniature construction set Power and Control Bus with all of it's features as shown in FIG. 8, all of the Figurines shown in FIG. 15 and sufficient connectors and clips for the full assembly. The following miniature construction set components would be included: Master Foundation Platform component 2; Floor Covering components 4; Stage Platform components 10; Stage Top Support components 12; Stage Top components 14; Speaker Support components 16; Video Monitor Support components 18; Stage Railing Components 20; Half Height Stage components 22; Stair components 24; Sub-woofer Speaker components 30; Full Range Speaker Array components 32; Floor Monitor components 34; Standard Light components 40; Moving Light components 42; Lighting Array components 46; Small Video Monitor components 50; Large Background Video Monitor components 56; Guitar Amplifier components 60; Bass Guitar Amplifier components 62; Drum Set components 70; DJ Booth components 80; DJ Booth Controller A components 82; DJ Booth Controllers B components 84; DJ Booth Controllers C components 86; DJ Booth Controllers D components 88; Curtain components 90; Stage Top Covering components 92; Lighting Control Station 410, Sound Control Station 412, Lighting Controllers A 420; Lighting Controllers B 422; Lighting Controllers C 424; Lighting Controllers D 426; Lighting Controllers E 428; Sound Controllers A 430; Sound Controllers B 432; Sound Controllers C 434; Sound Controllers D 436; Sound Controllers E 438; Stage Railing Components 440; Control Tower Top components 442; Standard Truss Components 452; Standard Truss Connectors 458; Multi-Angled Truss Connectors 456; Wide Truss Foundation 454; Focused Beam Light components 414; Camera Tripod 490; Full Range Speaker Array 530; Vertical oriented Full Range Speaker 540; Horizontal oriented Full Range Speaker 542; Wedge Full Range Speaker 544; Full Range Speaker With Visible Horn 546; Full Range Speaker Array Element 548; Alternate Full Range Speaker Array Element 550; Wedge Style Stage Monitor 554; Sub-Woofer Array 560; Alternate Sub-Woofer Array 562; Sub-Woofer Array Element 564; Alternate Full Range Speaker With Visible Horn 570; Movable Ladder With Platform 610; Standard Curved Stair 612; Lighted Stair With Surround Walls and Ceiling 614; Standard Lighted Stair 616; Step Ladder 618; Ladder With Hooks Style A 620; Extender For Ladder With Hooks Style A 622; Ladder With Hooks Style B 624; Extender For Ladder With Hooks Style B 626; Lighted Stair With Open Sides 628; Standard Ramp 630; Stage Ladder Style A 632; Lighted Stair With Clear Sides 634; Lighted Stair With Solid Sides 636; Lighted Stairs With Platform Size A 640; Lighted Stairs With Platform Size B 642; Dance Floor Lighted Stairs Style A 646; Dance Floor Surround With Integrated Lighted Stairs 650; ALL OF THE ITEMS Described in FIG. 7 up to and through FIG. 10's DETAILED DESCRIPTION OF THE DRAWINGS; Large Video Monitor 1122; miniature construction set Scenic (a foam and/or plastic shell terrain with 3D elements, which can be put together from multi-parts) as shown in 1150; Video Monitor 1212; Optical Beam Splitter Mirror 1234; Figurine of a female Bass Guitar Player with Bass Guitar 1510; Figurine of a male Singer with Microphone 1520; Figurine of a male Drummer with Drum Kit 1530; Figurine of a female Guitar Player with Guitar 1540. The Eight Pointed Star Dual Male Hardware Connector ([1670, 1672 FIG. 16] and [1730, 1780, 1790 FIG. 17]) in conjunction with it's Eight Pointed Star Female Receptacle ([1682, 1688, 1664 FIG. 16] and [1720 FIG. 17]) is the preferred component hardware connector type and should be integrated into and used for all component hardware assembly where it is practical to use. The detailed description for the FIG. 16 and FIG. 17 drawings includes additional details about these connectors. Transparent hook and loop fasteners or other alternative means as described in this specification can be used for components when it is not practical or desired to use the Eight Pointed Star connectors.

The preferred embodiment would also have various miniature accessories such as a DJ Booth with accessories, Guitars, Keyboards, Mixers and Lighting Controllers as well as numerous additional figurines.

A Power and Control Bus(vehicle) as shown in FIG. 8 would provide power and interactive control of lighting, effects and robotics through USB, MIDI and DMX which can be wired or wireless. It would also be controlled through Audio from files, live microphones or live feeds from computers and smartphones. A unique miniature construction set universal protocol would be used for sending information between the system computer and external computers and smartphones.

Although the invention has been described in connection with a preferred embodiment, it should be understood that various modifications, additions and alterations may be made to the invention by one skilled in the art without departing from the spirit and scope of the invention as defined in the appended claims.

1. A miniature construction set comprising:
a plurality of stage components;
a plurality of truss components; and
eight pointed star component connectors, where at least two of the components are connected by a dual eight pointed star male connector which is inserted into an eight pointed star female receptacle, the dual eight pointed star male connector having seven main sections, which are from one end to the other, a tip section A, an alignment section A, a primary contact section A, a spacer section, a primary contact section B, an alignment section B and a tip section B, the female receptacle having an opening size that matches the primary contact section A or the primary contact section B.

2. The invention of claim 1 further comprising;
LED lights.

3. The invention of claim 1 further comprising;
addressable RGB LEDs.

4. The invention of claim 1 further comprising;
addressable RGB LEDs which are controllable by MIDI.

5. The invention of claim 1 further comprising;
addressable RGB LEDs which are controllable by DMX.

6. The invention of claim 1 further comprising;
moving lights.

7. The invention of claim 1 further comprising;
addressable RGB LEDs; and
moving lights.

8. The invention of claim 1 further comprising;
a video screen.

9. The invention of claim 1 further comprising;
a holographic image.

10. The invention of claim 1 further comprising;
audio input; and
audio output.

11. The invention of claim 1 further comprising;
addressable RGB LEDs;
moving lights;
an integrated computer system;
audio input;
audio output;
a video screen; and
a holographic image.

12. The invention of claim 1 further comprising;
addressable RGB LEDs;
moving lights;
an integrated computer system;
figurines;
audio input;
audio output;
a video screen; and
a holographic image.

13. The invention of claim 1 further comprising;
addressable RGB LEDs;
moving lights;
an integrated computer system;
a control bus;
figurines;
audio input;
audio output;
a video screen; and
a holographic image.

14. A miniature construction set comprising:
a plurality of stage components;
a plurality of truss components;
addressable RGB LEDs;
an integrated computer system; and
eight pointed star component connectors where at least two of the components are connected by a dual eight pointed star male connector which is inserted into an eight pointed star female receptacle, the dual eight pointed star male connector having seven main sections, which are from one end to the other, a tip section A, an alignment section A, a primary contact section A, a spacer section, a primary contact section B, an alignment section B and a tip section B, the female receptacle having an opening size that matches the primary contact section A or the primary contact section B.

15. The invention of claim 14 further comprising;
moving lights.

16. The invention of claim 14 further comprising;
a control bus.

17. The invention of claim 14 further comprising;
figurines.

18. The invention of claim 14 further comprising;
a video screen.

19. The invention of claim 14 further comprising;
a holographic image.

20. A connector set comprising:
a dual eight pointed star male connector which is inserted into an eight pointed star female receptacle, the eight pointed star male connector having seven main sections, which are from one end to the other, a tip section A, an alignment section A, a primary contact section A, a spacer section, a primary contact section B, an alignment section B and a tip section B; and
a female receptacle having an opening size that matches the primary contact section A or primary contact section B.
